(19) United States
(12) Patent Application Publication
(10) Pub. No.: US 2015/0101283 A1
(43) Pub. Date: Apr. 16, 2015

(54) DEVICE FOR PRODUCING A PACKAGING FOR TABLETS

(71) Applicant: Uhlmann Pac-Systeme GmbH & Co. KG, Laupheim (DE)

(72) Inventors: Peter Fuhrmann, Laupheim (DE); Fritz Fochler, Kammeltal-Behlingen (DE)

(21) Appl. No.: 14/510,759

(22) Filed: Oct. 9, 2014

(30) Foreign Application Priority Data
Oct. 10, 2013 (DE) 13188092.4

(51) Int. Cl. B65B 5/02; B65B 47/02; B65B 7/28; B65B 43/08; A61J 1/03; B65B 5/08

(52) U.S. Cl. CPC B65B 5/024; A61J 1/035; B65B 5/08; B65B 7/28; B65B 43/08; B65B 47/02
USPC 53/171

(57) ABSTRACT

The device for producing the packaging comprises a unit for producing blister packs, a unit for producing the packaging containers, a transfer device for transferring the blister packs in the packaging containers, a sealing station for the packaging containers, and preferably also a stamp, all of which are arranged in a single machine. The packaging for tablets thus manufactured has a packaging container and several blister packs, which are loosely accommodated in a holding section of the packaging container, and the holding section is sealed by a lidding sheet.

### RELATED APPLICATIONS

The present patent document claims the benefit of priority to European Patent Application No. EP 13188092.4, filed Oct. 10, 2013, the entire contents of which are incorporated herein by reference.

### FIELD AND BACKGROUND OF THE INVENTION

The present invention relates to a device for producing a packaging for tablets.

Blister packs stored in folding boxes are often used for the packaging of medical or pharmaceutical products. During the production of the blister packs in a blister machine, pockets to hold the medical or pharmaceutical products are first formed in a formable sheet. The products are placed in these pockets, and the formed sheet comprising the filled pockets is then sealed with a lidding sheet. By means of a transfer system, the blister packs produced in this way are sent from the blister machine to a downstream cartoning machine. In this cartoning machine, stacks of blister packs are formed and inserted into erected folding boxes, often along with a package insert. While still in the cartoning machine or in the following machines, safety measures such as those involving hot-melt adhesive seals, tamper-evident labels, tamper-evident sealing tabs, or shrink wrap can be carried out.

Because of the worrisome increase in counterfeit medications, security measures for detecting tampering with folding boxes or other types of packaging for medical products have become especially important. None of the above-mentioned solutions used in the past as security devices for detecting tampering with folding boxes is tamper-proof, nor does any one of them make it possible to verify the genuineness of a drug by identifying individual packages or to reliably detect tampering with the outer wrapping.

### SUMMARY OF THE INVENTION

It is an object of the present invention to provide a device for producing a packaging for tablets on the basis of which packaging tampering with the packaging can be reliably detected. It is a further object of the present invention to provide a device, by means of which this packaging can be produced especially effectively and inexpensively.

According to an aspect of the invention, the device for producing a packaging for tablets comprises the following elements as components of a single machine:

a) a unit for producing blister packs comprising wells filled with tablets, the blister packs sealed with a first lidding sheet;

wherein the unit for producing blister packs comprises a heating station for heating a first formable sheet, a first forming station for forming the wells in the first formable sheet, a filling station for filling the wells with tablets, a first sealing station for sealing the first formable sheet having the wells with a first lidding sheet, and a first stamp for stamping out the individual blister packs from the first formable sheet sealed with the first lidding sheet;

b) a unit for producing packaging containers, in which one or more blister packs are to be loosely accommodated;

wherein the unit for producing packaging containers comprises a second forming station for forming pocket-like holding sections in a second formable sheet;

c) a transfer device for loosely placing the one or more blister packs in the packaging container; and

d) a closing device for closing the packaging container, wherein the closing device for closing the packaging container comprises a second sealing station, which serves to seal a second lidding sheet to the formed second formable sheet.

In this way, the packaging for tablets can be produced especially easily and at low production cost. In addition to further simplifications of the process technology, the production of the packaging from formable plastic sheet in this device also offers the advantage that a continuous feed of folding boxes is no longer necessary, and a decrease in logistical complexity is achieved through the elimination of the need to acquire and store folding boxes, hot-melt adhesive, etc. Since the unit for producing blister packs, the unit for producing packaging containers, the transfer device for placing the blister packs in the packaging containers, and the closing device for closing the packaging containers are configured as components of a single machine, two machine functions can be integrated into one system.

As a result, the entire machine has a length of no more than 10 m, and preferably of no more than 8 m. As a result of these features, the amount of production floor space required to accommodate such a shorter machine can be considerably reduced.

In a preferred embodiment, the device for producing a packaging for tablets also comprises a second stamp downstream from the second sealing station to stamp out a filled and sealed packaging container from the continuous strand of packaging containers. At the discharge end of the device, therefore, finished packages already separated from each other are obtained.

The device preferably also comprises a second heating station upstream of the second forming station to heat the second formable sheet. The forming of the holding sections into the second formable sheet is thus facilitated and proceeds in a manner less stressful to the formable sheet and to the forming tool.

In one embodiment of the device according to the invention, furthermore, the transfer device for loosely placing the one or more blister packs in the packaging container is designed as a transfer shaft, which dispenses blister packs downward in a controlled manner. As a result of this embodiment, the stacks of blister packs can be supplied to the packaging containers in stacks of any desired size.

In a preferred embodiment of the transfer device, the transfer shaft is also laterally movable. As a result, it is especially easy to adapt the dispensing position to the position of the packaging containers, especially when several packaging containers are processed per cycle.

The packaging for tablets manufactured by this device comprises a packaging container and one or more blister packs comprising tablet-filled wells, which are sealed by the first lidding sheet. The one or more blister packs are held loosely in the packaging container. The packaging container comprises a holding section formed from the second formable sheet, in which the one or more blister packs are loosely held and which is sealed by the second lidding sheet.

This type of packaging for tablets is dust-proof and air-tight and cannot be opened without leaving visible traces of the activity. In addition, this packaging can be produced more cheaply than conventional folding boxes.

The holding section of the packaging container is preferably configured as a pocket, in which the one or more blister packs are loosely placed. As a result, a dimensionally stable receptacle for the one or more blister packs is guaranteed.

The second lidding sheet can be sealed to the second formed sheet in the area of webs on the second formed sheet extending around the pocket. In this way, the second lidding sheet can be sealed especially easily and in a defined joint area to the second formed sheet.

Furthermore, a package insert may also be held loosely in the packaging container, and because these inserts have already been folded and set down onto the blister packs, it becomes possible to supply package inserts of relatively large size.

Preferably at least part of the formed sheet is printed. In another embodiment, at least part of the second lidding sheet is printed. In this way, the necessary package data such as product name, manufacturer's data, ingredients, or similar data can be applied directly to the packaging in a tamper-proof manner. The application of variable data including Braille script can be accomplished easily and inexpensively during the production process.

The second lidding sheet may comprise a perforation for tearing off part of the second lidding sheet, as a result of which it becomes easier to open the package. For a similar purpose, the second lidding sheet can also comprise a pull tab for pulling off the second lidding sheet from the packaging container.

### BRIEF DESCRIPTION OF THE DRAWINGS

Additional features and advantages of the present invention can be derived from the following description, which refers the drawings.

FIG. 1 is a schematic, cross-sectional view of one embodiment of the device according to the invention for producing a packaging for tablets;

FIG. 2 is an enlarged view of one end of the device shown in FIG. 1;

FIG. 3 is a perspective view of a packaging for tablets produced by the device according to the invention;

FIG. 4 is an exploded perspective of another embodiment of a packaging produced by the device according to the invention, with blister packs and a package insert, but without a lid;

FIG. 5 is a cross-sectional view in the transverse direction of the packaging of FIG. 4; and

FIG. 6 is a cross-sectional view in the longitudinal direction of the packaging of FIG. 4.

### DETAILED DESCRIPTION OF SPECIFIC EMBODIMENTS

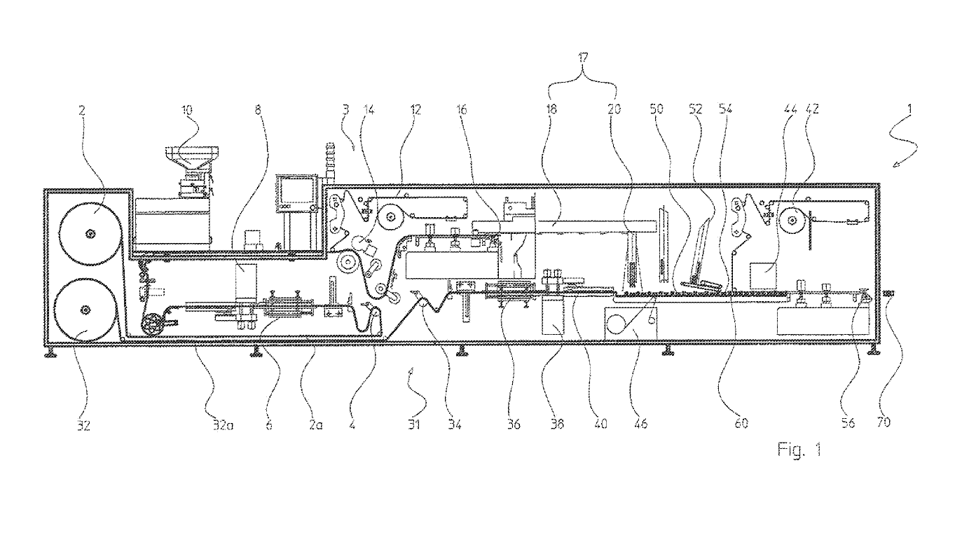

FIG. 1 shows by way of example an embodiment of the device 1 for producing packaging 70 for tablets. In a first production line inside the device 1, blister packs 50 are produced in a unit 3 for the production of blister packs 50. For this purpose, a first formable sheet 2a, originating from a first formable sheet roll 2, is supplied by way of a first formable sheet unwinder 4 to a first heating station 6, where it is heated. In the following first forming station 8, wells or pockets 66 intended to receive medical or pharmaceutical products such as tablets or the like are formed in the first formable sheet 2a. In a filling station 10, the pockets 66 of the first formable sheet 2a are filled with tablets 68. Originating from another supply roll, a first lidding sheet 12 is supplied to a first sealing station 14, in which the first lidding sheet 12 is sealed to the first formable sheet 2a, now comprising the filled pockets. A first stamp 16 then stamps out individual blister packs 50 from the first formable sheet 2a sealed with the first lidding sheet 12. The blister packs 50 are then placed loosely in packaging containers 60, the production of which is described in the following, by means of a transfer device 17. For example, the transfer device 17 comprises a suction belt 18 and/or a transfer shaft 20. Other types of transfer devices 17 are also conceivable, however.

The individual stations for producing blister packs 50 can vary with respect to their arrangement and individual configuration in accordance with the state of the art for blister machines.

In parallel with the production of the blister packs 50, in a second production line inside the device 1, the process—integrated into the machine—for producing the packaging containers 60 is started in a unit 31 for the production of packaging containers 60. For this purpose, the second formable sheet 32a stored on the second formable sheet roll 32 is passed underneath the first formable sheet 2a and is transported from the second formable sheet unwinder 34 to the second heating station 36, where it is heated. In a second forming station 38, holding sections 61 to hold one or more blister packs 50 are formed in the second formable sheet 32a to form the packaging 70. In addition, the packaging container 60 can be provided simultaneously in this station with Braille printing. The fully formed packaging container 60 is transported under the transfer shaft 20 by the forward feeder 40.

Additional embodiments are conceivable in which the two production lines together with their associated stations are arranged in some other way 3-dimensionally with respect to each other, and in which the blister packs 50 are brought by suitable transport means in some other way into a suitable transfer position relative to the packaging containers 60.

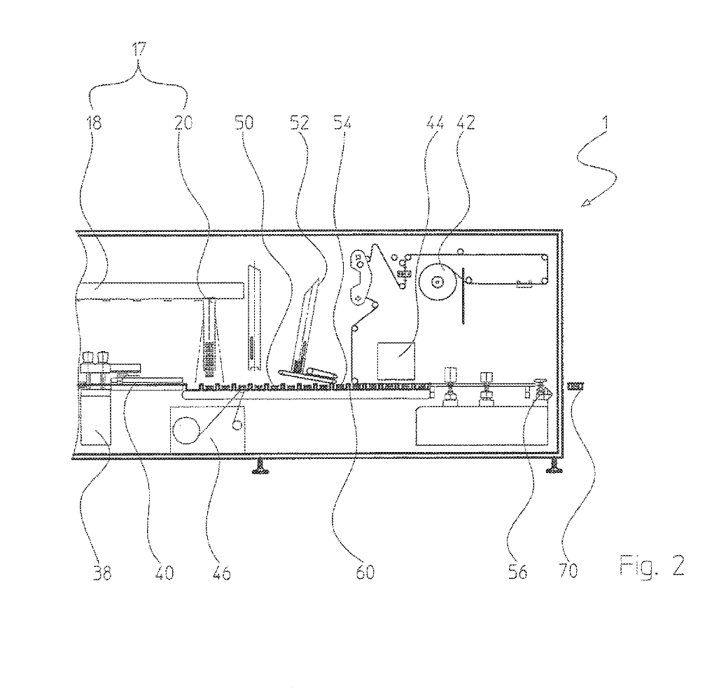

FIG. 2 shows the end section of the embodiment of the device 1 for producing packaging 70 for tablets, starting from the point at which the blister packs 50 coming from the transfer shaft 20 are brought together with the packaging containers 60 formed in the second formable sheet 32a. Underneath the transfer shaft 20, the holding sections 61 of the packaging containers 60 are loosely filled with the desired number of blister packs 50. The transfer shaft 20 is for this purpose preferably configured as a blister stack shaft and dispenses the blister packs 50 in a controlled manner in the downward direction. The number of packaging containers 60 conveyed under the transfer shaft 20 per feed cycle depends on the size of the blister packs 50. If several packaging containers 60 are moved through per cycle, the transfer shaft 20 will be moved in a suitable manner into the appropriate filling positions. During further transport, a labeler 46 applies labels with all the necessary package data (e.g., product name, manufacturer's data, ingredients, etc.) to the bottom of the package.

As the packages pass along the line, a prospectus inserter 52 dispenses the required package inserts 54 onto the blister pack stacks 50 which have previously been laid loosely in the holding sections 61 of the packaging containers 60. It is also possible to feed additional package insert materials such as brochures, calendar pages, etc., to the stacks. After the packaging containers 60 formed in the second formable sheet 32a have been filled with the desired number of blister packs 50 and the required and desired package inserts, the packaging containers 60 are closed in a closing device 44, preferably a second sealing station, with a second lidding sheet 42. The permanent closure in the closing device 44, serving among other things as effective protection against tampering, is accomplished by a suitable technique such as welding, heat-sealing, adhesive bonding, or ultrasound. It is also conceivable that separately formed and snapped-on lids could be welded to the packaging container 60. At the end, the closed packaging containers 60 pass by a second stamp 56, which stamps out the finished packaging 70 for tablets.

In addition to the previously mentioned labeling, other known identification and printing methods for identifying the packaging containers 60 can also be used. The package data can, for example, be printed directly on the packaging container 60 or on the second lidding sheet 42 or, for example, embossed into the packaging container 60 or the second lidding sheet 42. The data can be applied to the bottom and/or to the side walls of the packaging container 60 and/or to the second lidding sheet 42 as desired.

The line length of the overall device 1 for producing packaging 70 for tablets is less than 10 m, and preferably less than 8 m, including the sheet rolls 2, 32. The production method for the packaging 70 can be executed with a single strand or, to increase the output, with multiple strands. It should also be pointed out that the process chain described here and illustrated in FIGS. 1 and 2 can be expanded at any point by additional functions such as stack control, printing systems, etc.

FIG. 3 shows an exemplary embodiment of the packaging 70 for tablets manufactured by the device 1. The packaging 70 comprises a packaging container 60 and a second lidding sheet 42 and is filled with one or more blister packs 50 and a package insert 54 or additional package content materials.

In the example shown here, the holding section 61 of the packaging container 60 is configured as a pocket. Other embodiments suitable for holding blister packs 50 are also conceivable. The packaging container 60 could be configured, for example, as a collection cup.

The packaging container 60 is also preferably formed out of thermoplastic sheet material. The use of other suitable materials which meet the requirements on formability, leak-tightness, sterility, etc. is also possible.

The holding section 61 of the packaging container 60 is also preferably provided with circumferential webs 62, at which the second lidding sheet 42 is bonded to the second formable sheet 32a forming the packaging container 60. Here, too, other embodiments are possible, in which the second lidding sheet 42 is attached directly to the side walls, for example, of the packaging container 60. It is important to remember, however, that it is always necessary to provide a joint surface of sufficient size and accessibility to guarantee that a leak-tight, permanent connection is established between the second formable sheet 32a and the second lidding sheet 42.

At least a portion of the second formable sheet 32a, which forms the packaging container 60, can be printed with product data.

The second lidding sheet 42, which closes the packaging container 60, can be formed out of any suitable, commercially available material such as aluminum, aluminum laminate, or, again, thermoplastic sheet material. This can be transparent or opaque. Depending on the selected method for attaching the second lidding sheet 42, the packaging container 60 can also be configured to be reclosable.

To make it easier to open the packaging container 60, the second lidding sheet 42 comprises, in the embodiment shown in FIG. 3, a perforation 64. In other embodiments, the packaging container 60 can comprise a pull tab for pulling off the second lidding sheet 42 instead of the perforation 64. Other measures familiar in the field of packaging technology can be provided to make it easier to open the package.

The finished packaging 70 for tablets can contain any desired number of blister packs 50 and package inserts 54. The depth of the packaging container 60 depends on the number of blister packs 50 and package inserts to be accommodated and can be varied accordingly.

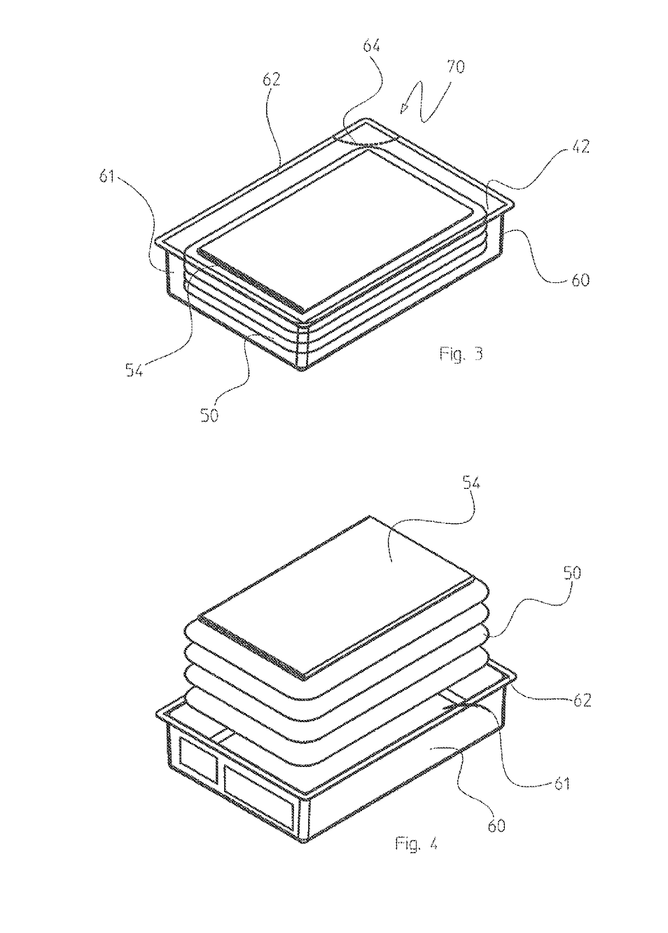

FIG. 4 shows an exploded view of another example of the packaging 70 produced by the device 1, wherein four blister packs 50 and one package insert 54 are stacked on top of each other in the packaging container 60. In alternative embodiments, the packaging container 60 is filled with only one blister pack 50 or with some other number of blister packs 50. In addition, any desired number of package inserts 54 or additional inserted materials of any desired size can be added. The package inserts are prefolded and deposited onto the loosely placed blister pack stack and therefore do not have to be inserted later, as is the case with conventional folding boxes.

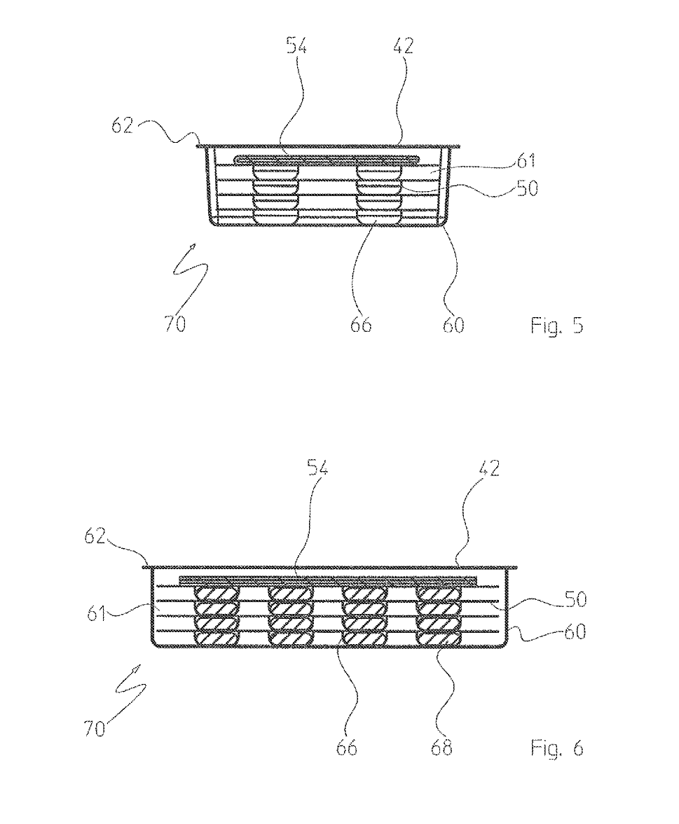

FIGS. 5 and 6 show cross-sectional views through an example of the packaging 70 as shown in FIG. 4. The transverse direction is defined here as the direction parallel to one of the shorter sides of the packaging container 60. The longitudinal direction is defined correspondingly as the direction parallel to one of the longer sides of the packaging container 60. FIG. 5 shows a cross-sectional view in the transverse direction, FIG. 6 a cross-sectional view in the longitudinal direction of the packaging container 60 of FIG. 4. The embodiment illustrated shows the accommodation of four blister packs 50, each with two pockets 66 arranged in the transverse direction and four pockets 66 arranged in the longitudinal direction to hold round tablets 68. A package insert 54 is also present in the packaging 70. Additional embodiments of the packaging 70 comprise the accommodation of any desired number of blister packs 50 and package inserts 54 and the accommodation of standard variants of blister packs 50 known to the person skilled in the art in any desired 3-dimensional orientation.

1. A device for producing a packaging for tablets, the device comprising the following elements as components of a single machine:
a) a unit for producing blister packs comprising wells filled with tablets, the blister packs sealed with a first lidding sheet;
wherein the unit for producing blister packs comprises a heating station for heating a first formable sheet, a first forming station for forming the wells in the first formable sheet, a filling station for filling the wells with tablets, a first sealing station for sealing the first formable sheet having the wells with a first lidding sheet, and a first stamp for stamping out the individual blister packs from the first formable sheet sealed with the first lidding sheet;
b) a unit for producing packaging containers, in which one or more blister packs are to be loosely accommodated;
wherein the unit for producing packaging containers comprises a second forming station for forming pocket-like holding sections in a second formable sheet;
c) a transfer device for loosely placing the one or more blister packs in the packaging container; and
d) a closing device for closing the packaging container, wherein the closing device for closing the packaging container comprises a second sealing station, which serves to seal a second lidding sheet to the formed second formable sheet.

2. The device for producing a packaging for tablets according to claim 1, wherein the single machine has a length of no more than 10 m, and preferably of no more than 8 m.

3. The device for producing a packaging for tablets according to claim 1, further comprising, downstream from the second sealing station, a second stamp, with which a filled and sealed packaging container is stamped out from a packaging container strand.

4. The device for producing a packaging for tablets according to claim 1, further comprising, upstream of the second forming station, a second heating station for heating the second formable sheet.

5. The device for producing a packaging for tablets according to claim 1, wherein the transfer device for loosely placing the one or more blister packs in the packaging containers is a transfer shaft, which dispenses the blister packs downward in a controlled manner.

6. The device for producing a packaging for tablets according to claim 5, wherein the transfer shaft is laterally movable.
